(19) United States
(12) Patent Application Publication
(10) Pub. No.: US 2024/0326891 A1
(43) Pub. Date: Oct. 3, 2024

(54) FRAME FOLDING AND FIXING DEVICE AND BABY CARRIER

(71) Applicant: Wonderland Switzerland AG, Steinhausen (CH)

(72) Inventors: Leilei ZHENG, Dongguan, Guangdong (CN); Liwu FANG, Dongguan, Guangdong (CN)

(73) Assignee: Wonderland Switzerland AG, Steinhausen (CH)

(21) Appl. No.: 18/579,761

(22) PCT Filed: Aug. 1, 2022
(86) PCT No.: PCT/EP2022/071584

§ 371 Date: Jan. 16, 2024

(30) Foreign Application Priority Data
Aug. 2, 2021 (CN) 2021 10880960.1

(51) Int. Cl. B62B 7/06; B62B 7/08

(52) U.S. Cl. CPC B62B 7/064; B62B 7/062; B62B 7/08; B62B 2205/20

(57) ABSTRACT

A frame folding and fixing device and a baby carrier are provided. The frame folding and fixing device includes a first locking device on a front leg of a frame and a second locking device on a handle of the frame. When the front leg of the frame is folded relative to the handle of the frame, the first locking device and the second locking device are rotated towards each other and locked; when the front leg of the frame is unfolded relative to the handle of the frame, the first locking device and the second locking device are rotated away from each other and unlocked. The frame folding and fixing device according to the disclosure may improve the overall aesthetics and use safety of the baby carrier, and may have a simple structure, low production cost and more convenient operation.

### TECHNICAL FIELD

The disclosure relates to a frame folding (retracting) and fixing device and a baby carrier including the frame folding and fixing device.

### BACKGROUND

The baby carrier can alleviate the fatigue caused by holding the baby for a long time, and improve the comfort of people's life. The main structure of the baby carrier usually includes a handle (grip) portion and a front leg portion. For conveniently storing and carrying the baby carrier when not in use temporarily, usually the handle portion and the front leg portion may be folded up relative to each other so as to reduce the occupied volume of the baby carrier.

Specifically, referring to FIG. 10, which is a schematic diagram showing a frame folding and fixing hook of the related art, a joint 30′ is arranged between a handle 10′ and a front leg 20′. Through the arrangement of the joint 30′, the handle 10′ and the front leg 20′ may be folded up or unfolded (extended) relative to each other, such that the baby carrier may be conveniently stored and carried when not in use temporarily and may be unfolded again for use.

In order to lock the folded state of the baby carrier and prevent it from being opened (unfolded) undesirably, according to the related art shown in FIG. 10, a frame folding and fixing hook 40′ is provided. One end of the frame folding and fixing hook 40′ is fixedly arranged on, for example, the front leg 30′, and the other end thereof is provided in the form of a hook. When the handle 10′ and the front leg 20′ are in the folded state, the other end of the frame folding and fixing hook 40′ is hooked on, for example, the handle 10′, so as to lock the folded state of the baby carrier. When the handle 10′ and the front leg 20′ need to be unfolded relative to each other again, it is necessary to manually release the other end of the hook of the frame folding and fixing hook 40′, so as to release (i.e., unlock) the folded and locked state of the baby carrier.

However, the above-mentioned frame folding and fixing hook 40′ in the related art has following problems. The frame folding and fixing hook 40′ exposed to the outside of the frame has poor aesthetics, and needs to be manufactured separately and then connected to the baby carrier, thereby increasing the manufacture processes and production cost. In addition, when the baby carrier is in the unfolded state, the exposed frame folding and fixing hook 40′ naturally hangs down on the handle 10′ or the front leg 20′, so that it is very easy to accidentally injure the user and reduce the use safety of the baby carrier.

### SUMMARY

In view of the above, an objective of the disclosure is to provide a frame folding and fixing device and a baby carrier including the frame folding and fixing device, and specifically, to provide such a frame folding and fixing device which can overall improve the aesthetics and use safety of the baby carrier, and can effectively reduce the technological processes and production cost.

Thus, according to an aspect of the disclosure, there is provided a frame folding and fixing device, including a first locking device on a front leg of a frame and a second locking device on a handle of the frame. When the front leg of the frame is folded relative to the handle of the frame, the first locking device and the second locking device are rotated towards each other and locked; when the front leg of the frame is unfolded relative to the handle of the frame, the first locking device and the second locking device are rotated away from each other and unlocked.

In an embodiment, the first locking device includes a base and a boss, and the boss is disposed on the base and at a side of the base.

In an embodiment, the second locking device includes an arc rib and a locking projection, and the arc rib is fitted on the base and can slides on the base.

In an embodiment, when the front leg of the frame is folded relative to the handle of the frame, the arc rib slides on the base, and the locking projection and the boss can be locked; when the front leg of the frame is unfolded relative to the handle of the frame, the arc rib slides on the base in reverse, and the locking projection can be unlocked with the boss.

In an embodiment, the arc rib extends an arc length corresponding to a specific angle by which the handle needs to rotate relative to the front leg when being fully folded up.

In an embodiment, the first locking device includes a boss and a stopper, and the boss and the stopper are disposed opposite to each other.

In an embodiment, the second locking device includes an arc groove and a locking projection, the locking projection is disposed in the arc groove and protrudes toward the interior of the arc groove, and the boss and the stopper are fitted in the arc groove.

In an embodiment, when the front leg of the frame is folded relative to the handle of the frame, the boss and the stopper slide in the arc groove, and the locking projection is locked with the boss; when the front leg of the frame is unfolded relative to the handle of the frame, the boss and the stopper slide in the arc groove in reverse, and the locking projection is unlocked with the boss.

In an embodiment, the arc groove extends an arc length corresponding to a specific angle by which the handle needs to rotate relative to the front leg when being fully folded up.

According to another aspect of the disclosure, there is provided a baby carrier, including a handle, a front leg, a joint between the handle and the front leg, and the above-mentioned frame folding and fixing device, and the frame folding and fixing device is arranged at the joint.

In an embodiment, the handle is provided with a handle fastener, and the front leg is provided with a front leg fastener.

In an embodiment, the joint includes a first housing, a second housing, and a close cover for covering the first housing and the second housing. The front leg fastener is connected with the first housing, and the first locking device is disposed on the first housing; the handle fastener is connected with the second housing, and the second locking device is disposed on the second housing.

In an embodiment, the baby carrier further includes a frame unfolding and locking member and an resilient member arranged in the joint.

According to the frame folding and fixing device and the baby carrier including the frame folding and fixing device of the disclosure, the frame folding and fixing device is hidden in the joint of the baby carrier, so as to improve the overall aesthetics and use safety of the baby carrier. In addition, the frame folding and fixing device according to the disclosure has a simple structure, and does not need to be separately manufactured and then be connected, so that the technological processes and production cost can be effectively reduced. Further, the frame folding and fixing device according to the disclosure is more convenient to operate.

### BRIEF DESCRIPTION OF DRAWINGS

The accompanying drawings are included herein to provide a further understanding of the disclosure, and are incorporated into this specification to constitute a part of this specification. The accompanying drawings illustrating embodiments of the disclosure are used together with the following description to explain the concept of the disclosure.

In the drawings:

FIG. 1 is a schematic diagram showing a baby carrier according to the disclosure, wherein the handle is in an unfolded state relative to the front leg;

FIG. 2 is an exploded schematic diagram showing the specific structure of the joint of the baby carrier according to the disclosure;

FIG. 3 is a schematic diagram showing the structure of the frame folding and fixing device according to the disclosure;

FIG. 4 is a schematic diagram showing the baby carrier according to the disclosure, in which the handle is in the unfolded state relative to the front leg;

FIG. 4A is an enlarged view showing the details of the part Ain FIG. 4;

FIG. 5 is a schematic diagram showing the baby carrier according to the disclosure, in which the handle is in a semi-folded state relative to the front leg;

FIG. 5A is an enlarged view showing the details of the part Ain FIG. 5;

FIG. 6 is a schematic diagram showing the baby carrier according to the disclosure, in which the handle is in a fully-folded state relative to the front leg;

FIG. 6A is an enlarged view showing the details of the part Ain FIG. 6;

FIG. 7 is a schematic diagram showing the baby carrier according to the disclosure, in which the handle is in a state to restart unfolding relative to the front leg;

FIG. 7A is an enlarged view showing the details of the part Ain FIG. 7;

FIG. 8 and FIG. 9 are schematic diagrams showing a frame folding and fixing device according to another embodiment of the disclosure, wherein FIG. 8 shows that the frame folding and fixing device is in an unlocked state, and FIG. 9 shows that the frame folding and fixing device is in a locked state; and

FIG. 10 is a schematic diagram showing a frame folding and fixing hook of the related art.

### LIST OF REFERENCES

1 baby carrier
10 handle
12 handle fastener
20 front leg
22 front leg fastener
30 joint
32 first housing
34 second housing
36 close cover
40 frame folding and fixing device
42 first locking device
421 base
422 boss
423 stopper
44 second locking device
441 arc rib
442 locking projection
443 arc groove
50 frame unfolding and locking member
60 resilient member

### DETAILED DESCRIPTION

Hereinafter, exemplary embodiments will be described in detail with reference to the accompanying drawings. Although the disclosure is susceptible to various modifications and alternative forms, its specific embodiments are shown by way of example in the accompanying drawings. However, the disclosure should not be construed as being limited to the embodiments set forth herein, and instead, the disclosure will cover all modifications, equivalents, and alternatives falling within the spirit and scope of the embodiments.

The frame folding and fixing device of the disclosure may be used in combination with various forms of baby carriers, for example baby strollers, children's tricycles, children's bicycles, children's balance vehicles, fan handle vehicles, etc., to lock folded states of various baby carriers. For the convenience of description, the following detailed description mainly refers to an example of the baby carrier in the form of the baby stroller.

The following is a detailed description of the frame folding and fixing device 40 and the baby carrier 1 including the frame folding and fixing device 40 according to the disclosure with reference to the accompanying drawings.

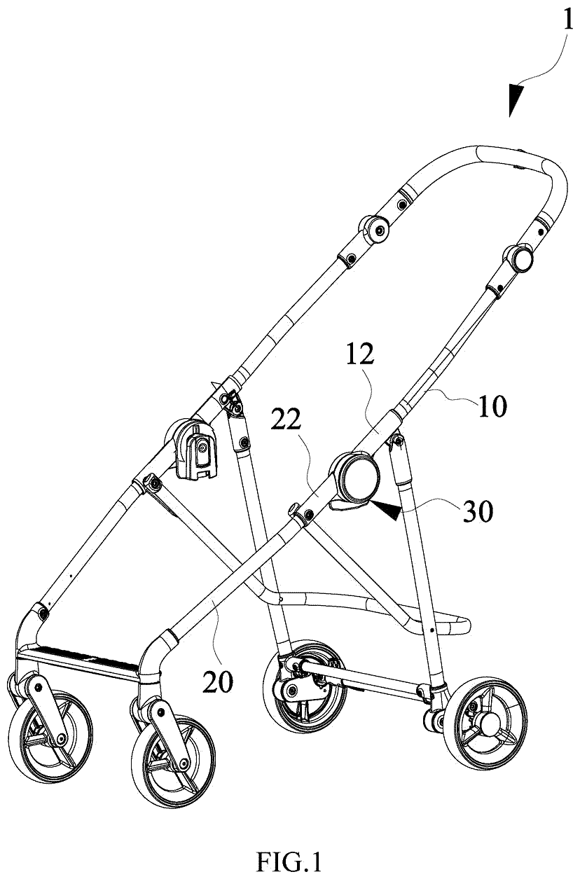

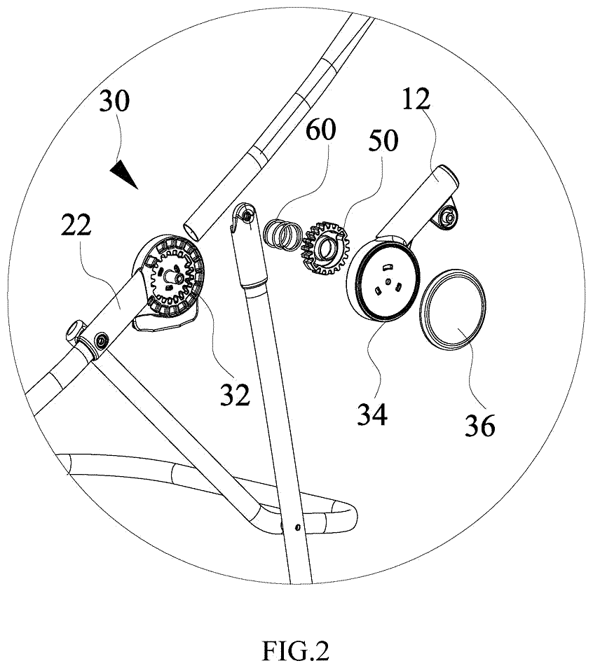

FIG. 1 is a schematic diagram showing a baby carrier 1 according to the disclosure, in which the handle 10 is in an unfolded state relative to the front leg 20. According to the embodiment shown in this figure, the baby carrier 1 includes a handle 10, a front leg 20, and a joint 30 between the handle 10 and the front leg 20. Further, as shown in FIG. 1, the handle 10 is provided with a handle fastener 12, and the front leg 20 is provided with a front leg fastener 22. And, as shown in FIG. 2, which is an exploded schematic diagram showing the specific structure of the joint 30 of the baby carrier 1 according to the disclosure, the joint 30 includes a first housing 32, a second housing 34, and a close cover 36 for covering the first housing 32 and the second housing 34. In the illustrated embodiment, the first housing 32 is provided on the front leg fastener 22, the second housing 34 is provided on the handle fastener 12. Further, a frame unfolding and locking member 50 and an resilient member 60 are also provided in the joint 30.

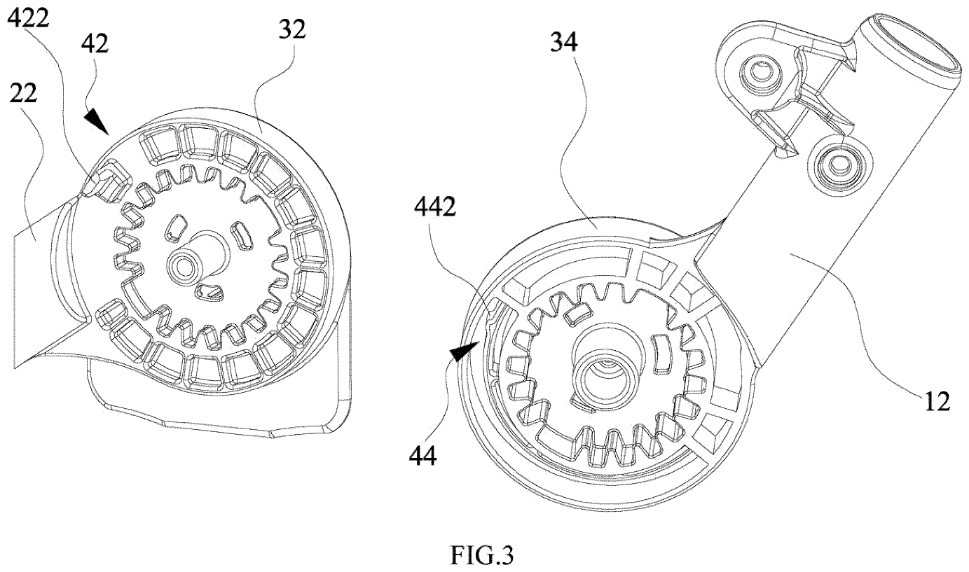

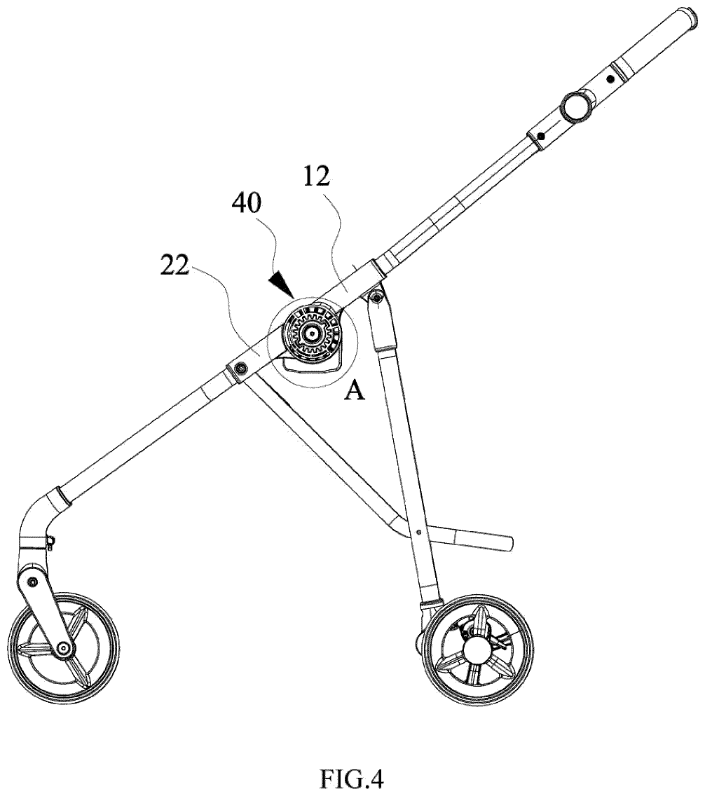

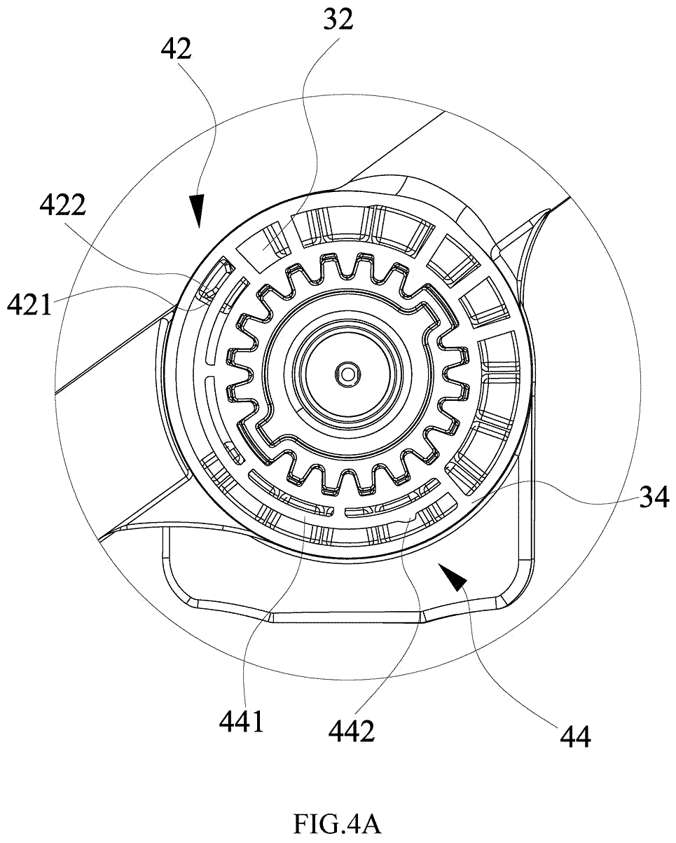

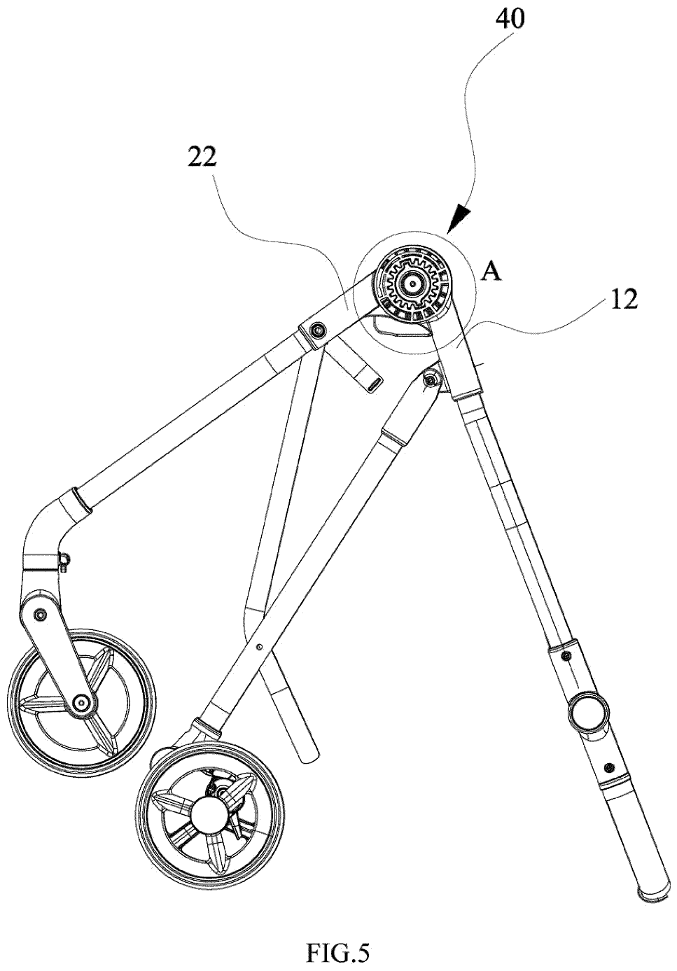

Next, referring to FIG. 3 and FIG. 4, the frame folding and fixing device 40 according to the disclosure will be described. FIG. 3 is a schematic diagram showing the structure of the frame folding and fixing device 40 according to the disclosure. The frame folding and fixing device 40 is disposed in the joint 30, and includes a first locking device 42 on the front leg 20 of the frame and a second locking device 44 on the handle 10 of the frame. Specifically, the first locking device 42 is disposed on the first housing 32 of the joint 30 connected with the front leg fastener 22; and the second locking device 44 is disposed on the second housing 34 of the joint 30 connected with the handle fastener 12. When the front leg 20 of the frame is folded relative to the handle 10 of the frame, the first locking device 42 and the second locking device 44 can be locked after rotating towards each other; when the front leg 20 of the frame is unfolded relative to the handle 10 of the frame, the first locking device 42 and the second locking device 44 is unlocked and rotated away from each other.

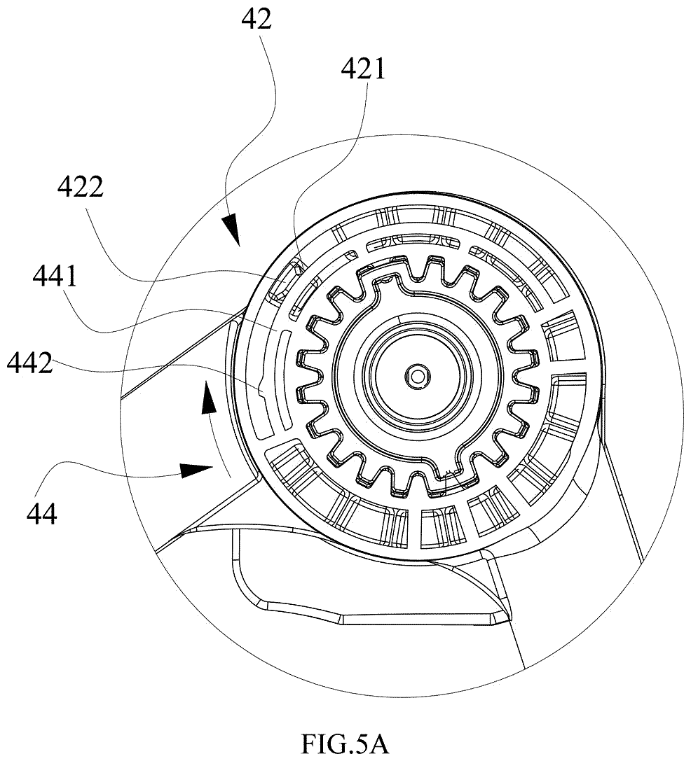

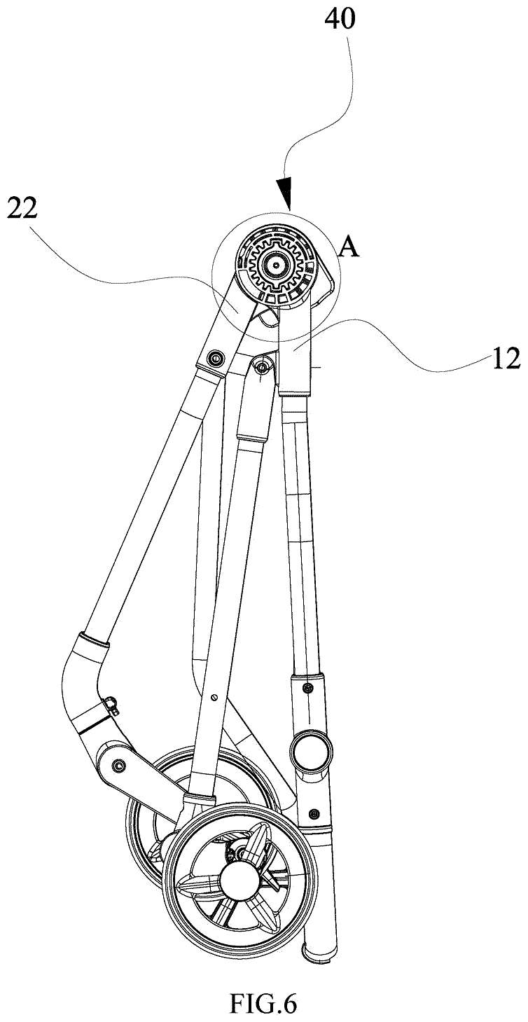

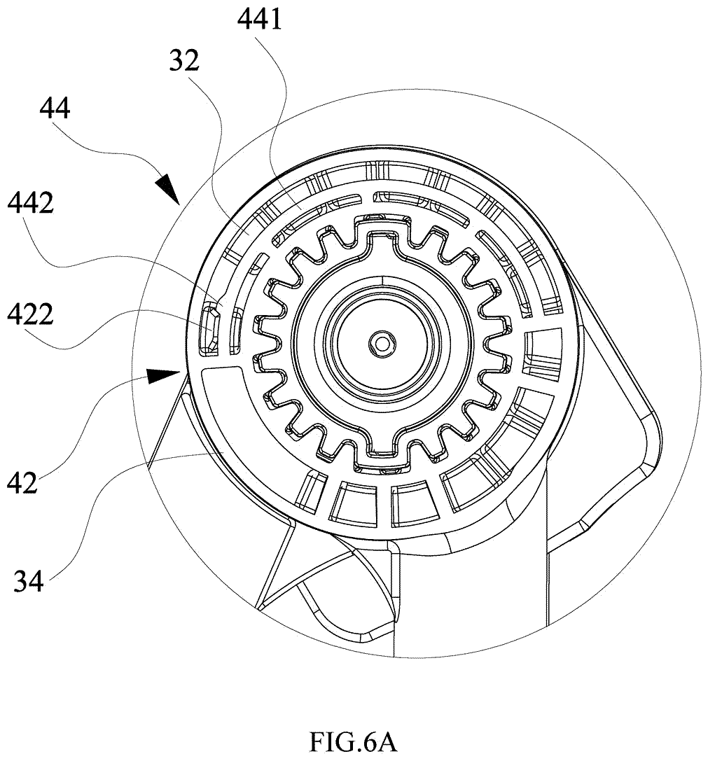

Hereafter, the specific actions of the first locking device 42 and the second locking device 44 during the front leg 20 is folded relative to the handle 10 will be described in detail with reference to FIG. 4-FIG. 6. FIG. 4 is a schematic diagram showing the baby carrier 1 according to the disclosure, in which the handle 10 is in the unfolded state relative to the front leg 20. FIG. 5 is a schematic diagram showing the baby carrier 1 according to the disclosure, in which the handle 10 is in a semi-folded state relative to the front leg 20. FIG. 6 is a schematic diagram showing the baby carrier 1 according to the disclosure, in which the handle 10 is in a fully-folded state relative to the front leg 20.

When the handle 10 is in the unfolded state relative to the front leg 20, referring to FIG. 4A which is an enlarged view showing the details of the part Ain FIG. 4, according to the embodiment as shown, the first locking device 42 includes a base 421 and a boss 422. The boss 422 is provided on the base 421 and at a side of the base 421. The second locking device 44 includes an arc rib 441 and a locking projection 442. The arc rib 441 is fitted on the base 421 of the first locking device 42 and can slide on the base 421. When the handle 10 of FIG. 4 is in the unfolded state relative to the front leg 20, the boss 422 of the first locking device 42 is away from the locking projection 442 of the second locking device 44 in the circumferential direction. When the handle 10 of FIG. 5 is in the semi-folded state relative to the front leg 20, as shown in FIG. 5A, which is an enlarged view showing the details of the part A in FIG. 5, the arc rib 441 slides on the base 421 in the clockwise direction indicated by the arrow shown in this figure, and the locking projection 442 gradually approaches the boss 422 in the circumferential direction. Further, when the handle 10 of FIG. 6 is in the fully-folded state relative to the front leg 20, as shown in FIG. 6A, which is an enlarged view showing the details of the part A in FIG. 6, the arc rib 441 continues to slide in the clockwise direction so as to drive the locking projection 442 to pass over the boss 422 and then be locked with the boss 422. Thus, when the handle 10 and the front leg 20 are in the fully-folded state, the above-mentioned fully-folded state is locked by the locking of the locking projection 442 and the boss 422 so as to avoid the fully-folded state from being undesirably unfolded (opened).

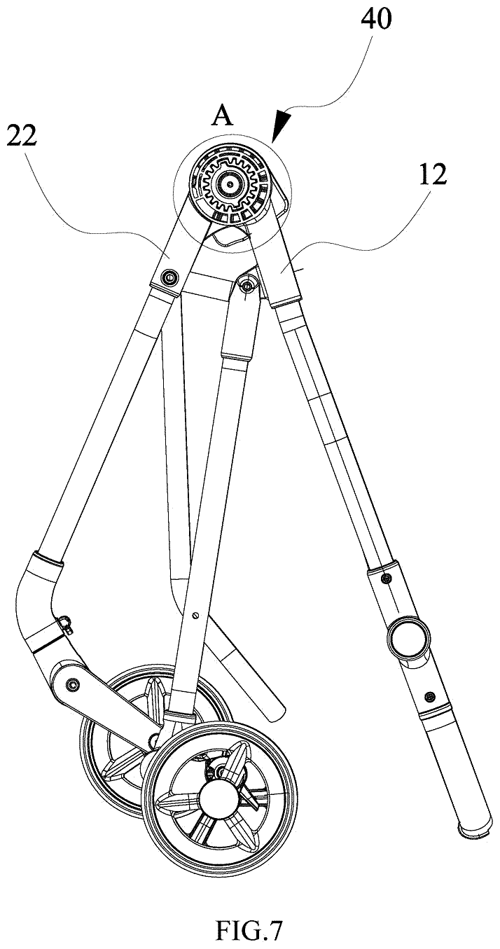

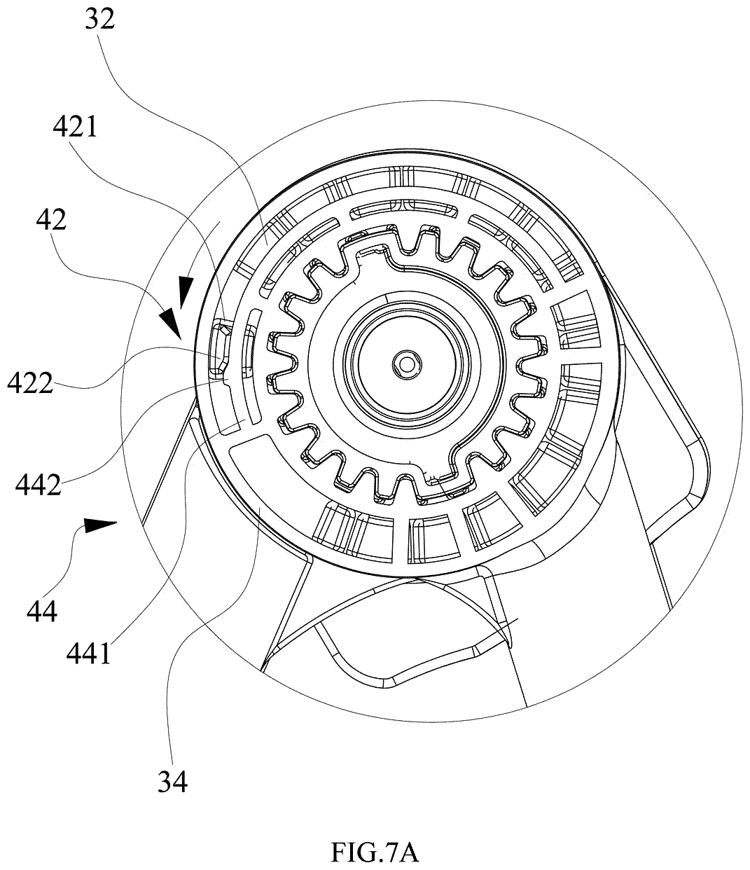

FIG. 7 and FIG. 7A illustrate the case when the baby carrier 1 needs to be unfolded again for continuous use. FIG. 7 is a schematic diagram showing the baby carrier 1 according to the disclosure in which the handle 10 is in a state to restart unfolding relative to the front leg 20, and FIG. 7A is an enlarged view showing the details of the part A in FIG. 7. At this time, the user may forcibly lift the handle 10 upwardly, such that the arc rib 441 of second locking device 44 slides in the counterclockwise direction indicated by the arrow in FIG. 7A, the locking projection 442 passes over the boss 422 in the counterclockwise direction correspondingly, then the lock of the fully-folded state is released or removed, and the user may conveniently unfold the handle 10 relative to the front leg 20.

The handle 10 needs to rotate a specific angle when the handle is fully folded relative to the front leg 20. In an embodiment, the handle needs to rotate about 90-180 degrees, preferably about 100-120 degrees, and more preferably about 103-110. Thus, according to the preferred embodiment shown in this figure, the arc rib 441 extends an arc length corresponding to the specific angle, which the handle 10 needs to rotate relative to the front leg 20 when being fully folded up, to meet the travel distance of the handle 10 relative to the front leg 20 during being fully folded up. For example, the arc length of the arc rib may be in the range of about one-quarter to about one-half of the circumference length.

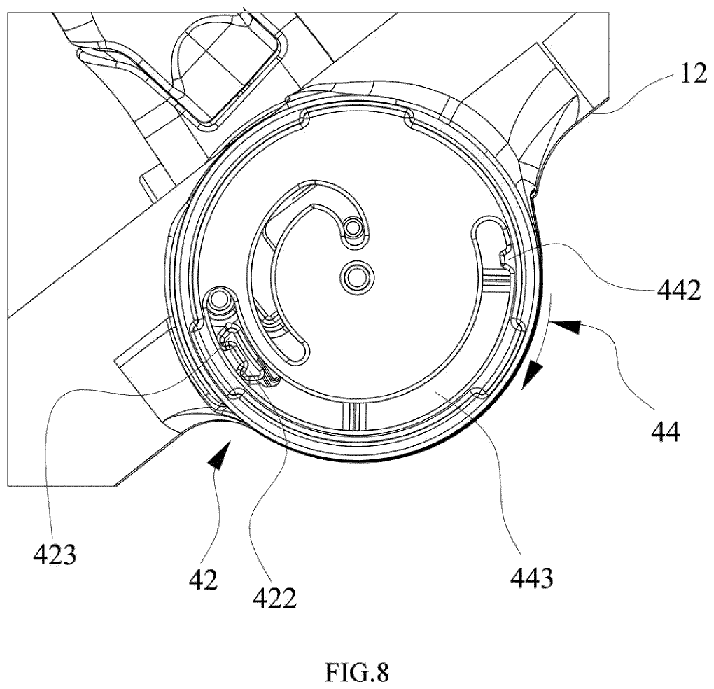

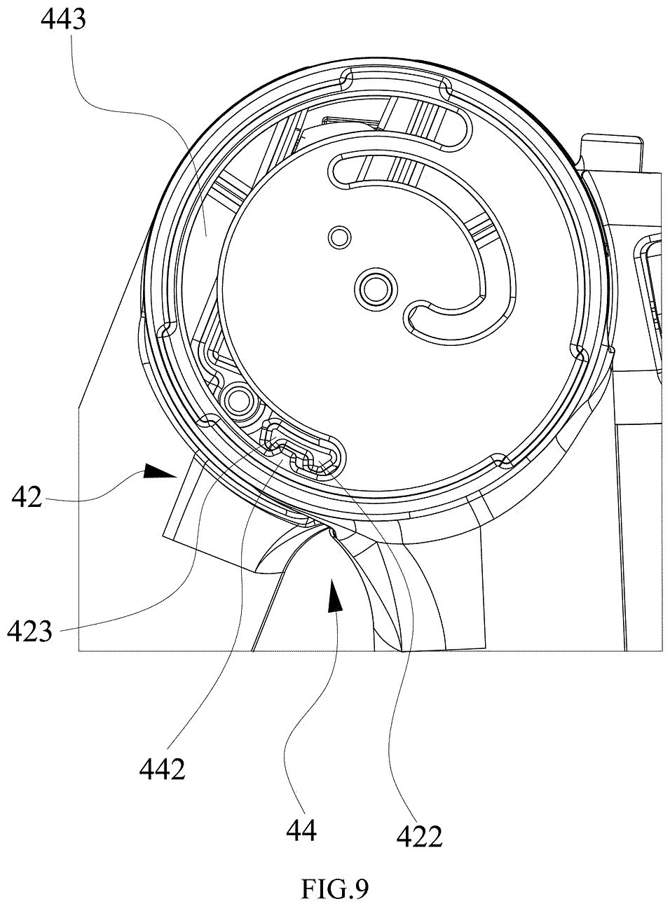

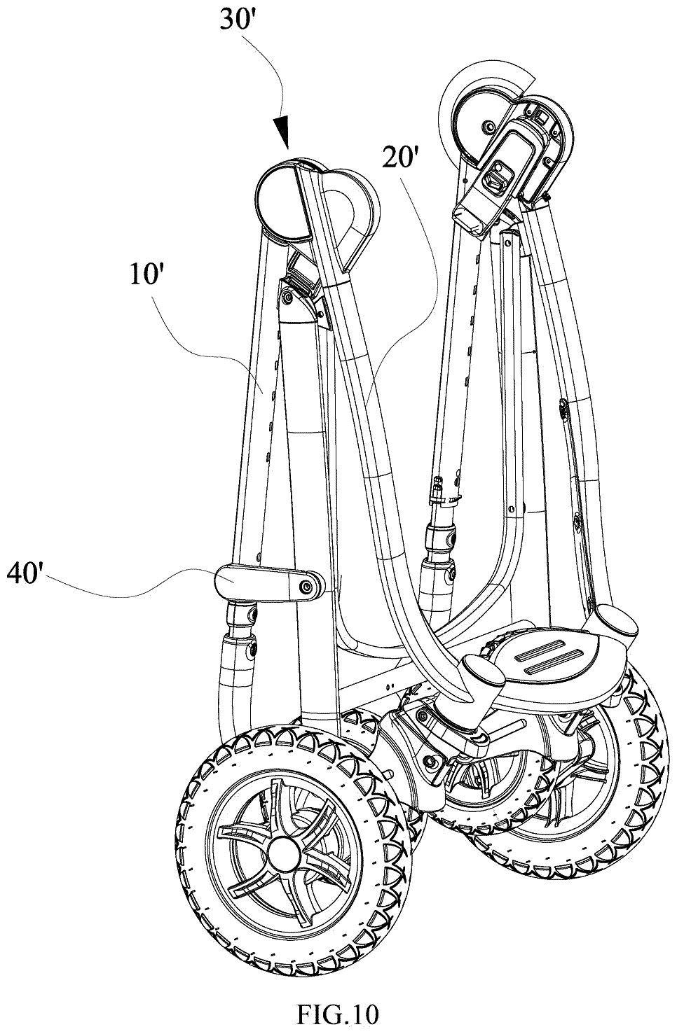

Next, referring to FIG. 8 and FIG. 9, the frame folding and fixing device 40 according to another embodiment of the disclosure will be described in detail. FIG. 8 and FIG. 9 are schematic diagrams showing the frame folding and fixing device 40 according to another embodiment of the disclosure, wherein FIG. 8 shows that the frame folding and fixing device 40 is in an unlocked state, and FIG. 9 shows that the frame folding and fixing device 40 is in a locked state. The differences between the frame folding and fixing device 40 according to this embodiment and the first embodiment are mainly described, and the same contents will not be repeated.

The first locking device 42 of the frame folding and fixing device 40 includes a boss 422 and a stopper 423, and the boss 422 and the stopper 423 are disposed opposite to each other. The second locking device 44 of the frame folding and fixing device 40 includes a locking projection 442 and an arc groove 443. The locking projection 442 is disposed in the arc groove 443 and protrudes towards the interior of the arc groove 443. The boss 422 and the stopper 423 of the above mentioned first locking device 42 are also fitted in the arc groove 443. Based on the above structure, in the unlocked state as shown in FIG. 8, the locking projection 442 is away from the boss 422 in the circumferential direction. During the handle 10 is gradually folded relative to the front leg 20, the locking projection 442 slides in the clockwise direction indicated by the arrow in FIG. 8, the arc groove 443 also slides in the clockwise direction along with it, and the boss 422 and the locking projection 442 gradually approach in the circumferential direction. After the handle 10 is fully folded relative to the front leg 20, the locking projection 442 passes over the boss 422 and locks with the boss 422. The stopper 423 disposed opposite to the boss 422 may prevent the locking projection 442 from sliding out of the locking with the boss 422. This may ensure the fully-folded state of the baby carrier 1 and avoid from being unfolded undesirably. When the baby carrier needs to be unfolded again for continuous use, the user may forcibly lift the handle, such that the locking projection 442 slides in the counterclockwise direction to release the locking with the boss 442 and thereby to unlock the folded state of the baby carrier.

Likewise, the arc length of the arc groove 443 also corresponds to the specific angle, which the handle 10 needs to rotate relative to the front leg 20 when being fully folded up, to meet the travel distance of the handle 10 relative to the front leg 20 during the fully folding process.

The frame folding and fixing device 40 according to the disclosure is hidden in the joint 30, which increases the overall aesthetics of the baby carrier 1. The hidden frame folding and fixing device 40 avoids the security risks caused by the exposed arrangement of the frame folding and fixing hook in the related art, and greatly improve the use safety of the baby carrier. The frame folding and fixing device 40 according to the disclosure is simple in structure, does not need additional processing steps and assembly processes, and thereby may reduce the production cost. Further, the frame folding and fixing device 40 according to the disclosure also has the beneficial effect of being easy to operate.

Since the features of the disclosure can be embodied in various forms without departing from the characteristics of the disclosure, it should also be understood that the above-mentioned embodiments are not limited to any details described above, unless otherwise noted, and should be broadly interpreted as falling within the scope defined by the appended claims. Therefore, all modifications and alterations falling within the scope and limit of the claims or equivalent solutions of such scope and limit shall be covered by the appended claims.

1. A frame folding and fixing device, comprising:
a first locking device on a front leg of a frame;
a second locking device on a handle of the frame, when the front leg of the frame is folded relative to the handle of the frame, the first locking device and the second locking device are rotated towards each other and locked; when the front leg of the frame is unfolded relative to the handle of the frame, the first locking device and the second locking device are rotated away from each other and unlocked.

2. The frame folding and fixing device according to claim 1, wherein the first locking device includes a base and a boss, and the boss is disposed on the base and at a side of the base.

3. The frame folding and fixing device according to claim 2, wherein the second locking device includes an are rib and a locking projection, and the are rib is fitted on the base and is configured to slide on the base.

4. The frame folding and fixing device according to claim 3, wherein, when the front leg of the frame is folded relative to the handle of the frame, the are rib slides on the base, and the locking projection is locked with the boss; when the front leg of the frame is unfolded relative to the handle of the frame, the are rib slides on the base in reverse, and the locking projection and the boss are unlocked.

5. The frame folding and fixing device according to claim 3, wherein the are rib extends an are length corresponding to a specific angle which the handle needs to rotate relative to the front leg when being fully folded up.

6. The frame folding and fixing device according to claim 1, wherein the first locking device includes a boss and a stopper, and the boss and the stopper are disposed opposite to each other.

7. The frame folding and fixing device according to claim 6, wherein the second locking device includes an are groove and a locking projection, the locking projection is disposed in the are groove and protrudes towards an interior of the are groove, and the boss and the stopper are fitted in the are groove.

8. The frame folding and fixing device according to claim 7, wherein, when the front leg of the frame is folded relative to the handle of the frame, the boss and the stopper slide in the are groove, and the locking projection is locked with the boss; when the front leg of the frame is unfolded relative to the handle of the frame, the boss and the stopper slide in the are groove in reverse, and the locking projection is unlocked with the boss.

9. The frame folding and fixing device according to claim 7, wherein the are groove extends an are length corresponding to a specific angle which the handle needs to rotate relative to the front leg when being fully folded up.

10. A baby carrier comprising a handle, a front leg, a joint between the handle and the front leg, and a frame folding and fixing device according to claim 1, the frame folding and fixing device being disposed at the joint.

11. The baby carrier according to claim 10, wherein the handle is provided with a handle fastener, and the front leg is provided with a front leg fastener.

12. The baby carrier according to claim 11, wherein the joint includes a first housing, a second housing, a close cover for covering the first housing and the second housing, the front leg fastener is connected with the first housing, and the first locking device is disposed on the first housing; the handle fastener is connected with the second housing, and the second locking device is disposed on the second housing.

13. The baby carrier according to claim 10, wherein the baby carrier further includes a frame unfolding and locking member and an resilient member in the joint.
